(19) United States
(12) Patent Application Publication
(10) Pub. No.: US 2025/0129823 A1
(43) Pub. Date: Apr. 24, 2025

(54) FRICTION CLUTCH OF A MULTISPEED TRANSMISSION AND ELECTRIC DRIVE OF A VEHICLE

(71) Applicant: Hoerbiger Antriebstechnik Holding GmbH, Schongau (DE)

(72) Inventors: Sami OEZKAN, Schongau (DE); Konrad LORY, Schongau (DE)

(21) Appl. No.: 18/919,748

(22) Filed: Oct. 18, 2024

(30) Foreign Application Priority Data
Oct. 23, 2023 (DE) 102023129109.2

(51) Int. Cl. F16D 27/115; F16D 13/52; F16D 23/14; F16D 27/11

(52) U.S. Cl. CPC F16D 27/115; F16D 13/52; F16D 23/14; F16D 27/11

(57) ABSTRACT

A friction clutch of a multispeed transmission is provided, including an actuating sleeve which is seated on a shaft and is adapted to be shifted linearly along the shaft, a first friction clutch unit arranged in the axial direction on one side of the actuating sleeve, a second friction clutch unit arranged in the axial direction on the side of the actuating sleeve which is opposite the first friction clutch unit, the actuating sleeve producing a frictional fit in the first friction clutch unit in a first engaged state, and a frictional fit in the second friction clutch unit in a second engaged state. An electric drive of a vehicle having a 2-speed transmission and an electric motor, which is coupled via a friction clutch according to the disclosure, is also provided.

### TECHNICAL FIELD

The present disclosure relates to a friction clutch of a multispeed transmission and to an electric drive of a vehicle.

### BACKGROUND

Multispeed transmissions are increasingly used in electric drive trains, in particular to increase efficiency.

One important requirement is a gear change without load interruption. For this purpose, the previous prior art often provides dual clutches, each having a clutch and an actuator assigned to the clutch for actuating the clutch.

However, this design is expensive to manufacture, complex and also requires more space and is heavy, in particular due to the two actuators.

Furthermore, a dual-clutch transmission requires precise control of the actuators so that the clutches open or close in precise synchronization with each other.

Against this background, the present disclosure is to provide a clutch which enables a gear change without load interruption and which at the same time can be manufactured cost-effectively and can be controlled in a simple and reliable manner.

### SUMMARY

The present disclosure provides a friction clutch of a multispeed transmission, comprising an actuating sleeve which is seated on a shaft and is adapted to be shifted linearly along the shaft between a first engaged state and a second engaged state, a first friction clutch unit arranged in the axial direction on one side of the actuating sleeve and comprising a first clutch body which is rotatably mounted on the shaft, a second friction clutch unit arranged in the axial direction on the side of the actuating sleeve which is opposite the first friction clutch unit and comprising a second clutch body which is rotatably mounted on the shaft, a first spring unit arranged axially between the actuating sleeve and the first friction clutch unit, a second spring unit arranged axially between the actuating sleeve and the second friction clutch unit, the spring units axially prestressing both friction clutch units when the actuating sleeve is in a neutral position, the actuating sleeve producing a frictional fit in the first friction clutch unit in the first engaged state, and a rotational connection being thus present between the shaft and the first clutch body, and the actuating sleeve producing a frictional fit in the second friction clutch unit in the second engaged state, and a rotational connection being thus present between the shaft and the second clutch body.

One basic idea of the present disclosure is to enable a gear change without load interruption by shifting the actuating sleeve from one engaged state via the neutral position into the other engaged state, so that a frictional fit in one friction clutch unit is released and a frictional fit is then immediately generated in the other friction clutch unit with a smooth transition.

This has the advantage that it is not necessary to coordinate when one of the friction clutch units is opened and the other is closed, as this is automatically controlled by shifting the actuating sleeve.

Furthermore, the structure according to the present disclosure allows a particularly space-saving clutch to be realized, since only one actuator is required for shifting the actuating sleeve.

One aspect provides that at least on one side facing the friction clutch units, the actuating sleeve has an axial bearing assigned thereto, on which the respective elastic spring unit is supported in the axial direction.

This ensures that in the event of a speed difference between the actuating sleeve and the clutch bodies, this causes no or less friction which would lead to wear on the actuating sleeve, the spring units or the friction clutches.

The axial bearing may be a needle bearing or a plain bearing comprising a sliding disk, for example a coated sliding disk.

If the axial bearing is designed as a needle bearing, this may provide a particularly robust and cost-effective axial bearing.

If the axial bearing is a plain bearing, the space requirement of the axial bearing, particularly in the axial direction, is particularly low, so that the friction clutch itself can also be designed to be more compact.

Alternatively, additional bearings or sliding rings may be omitted by an appropriate coating and/or hardening of the parts between which a relative speed may occur. In this alternative, the plain bearing or roller bearing is thus formed by the coating and/or hardening of the contacting parts themselves.

Consequently, a coating and/or hardening of the actuating sleeve and/or the clutch bodies and/or the spring units and/or the friction clutches could for example be carried out.

Furthermore, in a neutral position of the actuating sleeve, an at least approximately identical axial force may act respectively on the first and the second friction clutch unit, which is caused by the respectively prestressed associated first or second spring unit between the actuating sleeve and the first or second friction clutch unit.

On the one hand, this ensures that the actuating sleeve automatically assumes the neutral position without external forces, as the first and the second spring unit are also axially supported on the actuating sleeve.

On the other hand, the axial force acting in the neutral position on the first or the second friction clutch unit through the first and the second spring unit may be selected such that even a slight shifting of the actuating sleeve causes a frictional fit in one friction clutch unit, which allows at least the transmission of a determined minimum torque or also a transmission of the maximum possible torque (of the drive), while there is no longer any frictional fit in the other friction clutch unit.

It can thus be ensured that when the actuating sleeve is shifted from one engaged state to the other engaged state, a gear change can be performed almost instantaneously and at least approximately without load interruption.

Furthermore, with an axial shifting of the actuating sleeve into the first engaged state, the magnitude of the axial force acting on the second friction clutch unit may be zero or reduced compared to the neutral position. Alternatively or additionally, with an axial shifting of the actuating sleeve into the second engaged state, the magnitude of the axial force acting on the first friction clutch unit may be zero or reduced compared to the neutral position.

If the magnitude of the axial force drops to zero, this is particularly advantageous because the friction within the non-actuated friction clutch unit due to speed differences in the friction clutch can be reduced to a minimum, so that wear can also be reduced.

If the respective axial force is at least reduced compared to the neutral position when the actuating sleeve is shifted axially into an engaged state, any wear which may occur due to speed differences in the respective friction clutch can at least be reduced to a certain amount. However, since the neutral position hardly occurs in terms of time, this wear is negligible.

Furthermore, the first and/or the second clutch body may be coupled to a gear wheel for joint rotation therewith.

When the friction clutch is closed, torque is thus automatically transmitted from the shaft via the clutch body to the gear wheel coupled to the clutch body. The direct coupling of the clutch body and the gear wheel also enables a space-saving design.

The first and/or the second friction clutch unit may comprise a multidisk clutch.

Multidisk clutches are particularly suitable for transmitting high torques, they have low wear and require only a small amount of space in the axial direction.

The respective multidisk clutch may have an outer disk carrier which is formed by the respective clutch body or is coupled thereto for joint rotation therewith. Furthermore, outer disks may be provided within the outer disk carrier, which are coupled to the outer disk carrier for joint rotation therewith, and inner disks which are coupled to the shaft for joint rotation therewith.

If the outer disk carrier corresponds to the clutch body, it takes on several tasks at once and an additional clutch body is not required. This saves costs and installation space.

Furthermore, the outer disks of the respective multidisk clutch may be provided with a friction lining on both sides and the inner disks may be steel disks.

Furthermore, it is for example possible that the disk pack ends with an inner disk towards the actuation sleeve.

If there is no frictional fit within a friction clutch unit, it is possible that there is a speed difference between the shaft and the outer disk carrier.

This also results in a speed difference between the outer disks coupled to the outer disk carrier and the inner disks coupled to the shaft.

Since the actuating sleeve is arranged on the shaft and can be connected thereto for joint rotation therewith, for example, the actuating sleeve and thus also the elastic spring unit have the speed of the shaft.

To minimize wear at the contact point between the friction clutch unit designed as a multidisk clutch and the actuating sleeve or the elastic spring unit thereof, it is advantageous if the disk pack ends with an inner disk towards the actuating sleeve, since it has the same speed as the shaft.

Furthermore, it is advantageous if the disk pack ends with a steel disk (here the inner disk), as this allows axial forces acting from the actuating sleeve via a spring unit on a friction clutch unit to be introduced particularly evenly and in a planar manner into the multidisk clutch.

This results in a uniform surface pressure and thus ensures a reliable frictional fit when an actuating sleeve is engaged. In addition, any wear that may occur on the disks of the multidisk clutch occurs uniformly.

Furthermore, the first and/or the second friction clutch unit may comprise a cone clutch.

Consequently, it is possible for a friction clutch unit to have a multidisk clutch or a cone clutch, or even a friction clutch and a cone clutch.

Cone clutches have the advantage that particularly low actuating and holding forces already enable a frictional fit due to the cone angle. Compared to a multidisk clutch, lower axial forces are therefore required.

Furthermore, it is also possible that within a friction clutch, one friction clutch unit comprises a cone clutch and the other friction clutch unit comprises a multidisk clutch.

For example, the multidisk clutch could be used in the friction clutch which has to transmit higher torques, and the cone clutch could be used in the friction clutch which has to transmit low torques.

Alternatively, this is also possible the other way round, for example, if high friction power or friction energy is limited.

If only identical friction clutch units are used within a friction clutch, i.e. two multidisk clutches or two cone clutches, this simplifies production and assembly.

Furthermore, the higher quantities of identical components can reduce production costs.

The respective cone clutch may have an outer cone friction ring carrier which is coupled to the shaft for joint rotation therewith and is formed by the respective clutch body.

If the outer cone friction ring carrier corresponds to the clutch body, the latter takes on several tasks at once and an additional clutch body does not have to be provided. It is thus possible to save costs and installation space.

Furthermore, at least one first cone friction ring element which is coupled to the outer cone friction ring carrier for joint rotation therewith, and at least one second cone friction ring element which is coupled to the shaft for joint rotation therewith, may be arranged at least partially within the outer cone friction ring carrier, for example wherein the outer cone friction ring carrier has an inner cone surface against which the second cone friction ring element can rest, which is located between the outer cone friction ring carrier and the first cone friction ring element.

This arrangement allows a space-saving design of the cone clutch.

Furthermore, a plurality of friction surfaces may be provided so that the cone clutch is suitable for transmitting higher torques than would be the case if only an outer cone friction ring carrier and a single cone friction ring element were provided.

Furthermore, the respective cone clutch may comprise a first cone friction ring element and two cone friction ring elements between which the first cone friction ring element is located and which each have a friction surface facing the first cone friction ring element.

This design allows higher torques to be transmitted by the cone clutch than if it had only an outer cone friction ring carrier and a single cone friction ring element, as described above.

In addition, one of the second cone friction ring elements, which is coupled to the shaft for joint rotation therewith, forms the axial end of the cone clutch towards the elastic spring unit.

The respective elastic spring unit may be supported on the radially innermost cone friction ring element.

If this is a second cone friction ring element, as described above, it has no speed difference with the elastic spring element, so that there is no friction and thus no wear between the components.

The first and/or elastic spring unit may comprise at least one wave ring, one spring or a pack of these elements.

Both disk springs and wave springs are particularly suitable for this purpose, as they apply an axial force to the friction clutches uniformly along the entire circumference when they are prestressed or compressed.

Furthermore, disk springs and wave springs are particularly cost-effective parts.

In addition, the actuating sleeve may be arranged on the shaft for joint rotation therewith.

Alternatively, the actuating sleeve may be rotatably mounted on the shaft.

If the actuation sleeve is arranged on the shaft for joint rotation therewith, the friction clutch units can be designed such that the actuation sleeve always applies an axial force via the spring units to that part of the friction clutch unit which is also coupled to the shaft for joint rotation therewith, so that no relative speeds occur.

If the actuating sleeve is rotatably mounted on the shaft, the actuating sleeve can assume the speed of the respective friction clutch when one of the friction clutches is actuated, so that in case of a speed difference which may occur, the speeds are adjusted.

The actuating sleeve may be coupled to an electromechanical actuator or to a hydraulic actuator or to an electromagnetic actuator or to a ball ramp actuator for actuation.

An electromechanical actuator allows precise shifting and actuation of the actuating sleeve.

A particularly fast shifting of the actuating sleeve can be carried out with a hydraulic or electromagnetic actuator.

By means of a ball ramp actuator, it is also possible to adjust particularly precisely how far the actuating sleeve is to be shifted, wherein in this case, the actuating sleeve itself can be designed in several parts.

The object mentioned at the beginning is also achieved by an electric drive of a vehicle having a 2-speed transmission and an electric motor, which is coupled via a friction clutch according to the disclosure.

The advantages resulting therefrom can be found in the above paragraphs.

### BRIEF DESCRIPTION OF THE DRAWINGS

FIG. 1 shows a schematic representation of an electric drive according to the disclosure for vehicles having a multispeed transmission with a friction clutch according to the disclosure;

FIG. 2 shows a sectional view of the friction clutch according to the disclosure with friction clutch units according to a first alternative;

FIG. 3 shows a sectional view of the friction clutch according to the disclosure with friction clutch units according to a second alternative;

FIG. 4 shows a sectional view of the friction clutch according to the disclosure with friction clutch units according to a third alternative;

FIG. 5 shows a sectional view of the friction clutch according to the disclosure with an actuator according to a first option; and

FIG. 6 shows a sectional view of the friction clutch according to the disclosure with an actuator according to a second option.

### DETAILED DESCRIPTION

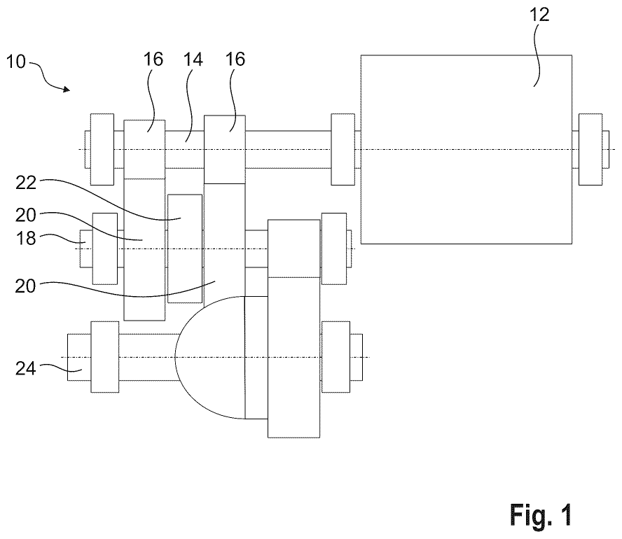

FIG. 1 shows, among other things, an electric drive of a vehicle having a multispeed transmission 10, which is designed as a two-speed transmission, for an electric motor 12 of a vehicle.

The multispeed transmission 10 has an input shaft 14 coupled to the electric motor 12, which is coupled via gear wheels 16 to gear wheels 20 arranged on a shaft 18.

In addition, a friction clutch 22 is provided on the shaft 18, by means of which it can be determined which of the gear steps formed by the gear wheels 16 and 20 is engaged.

The shaft 18 is in turn connected to an output shaft 24 via further gear wheels.

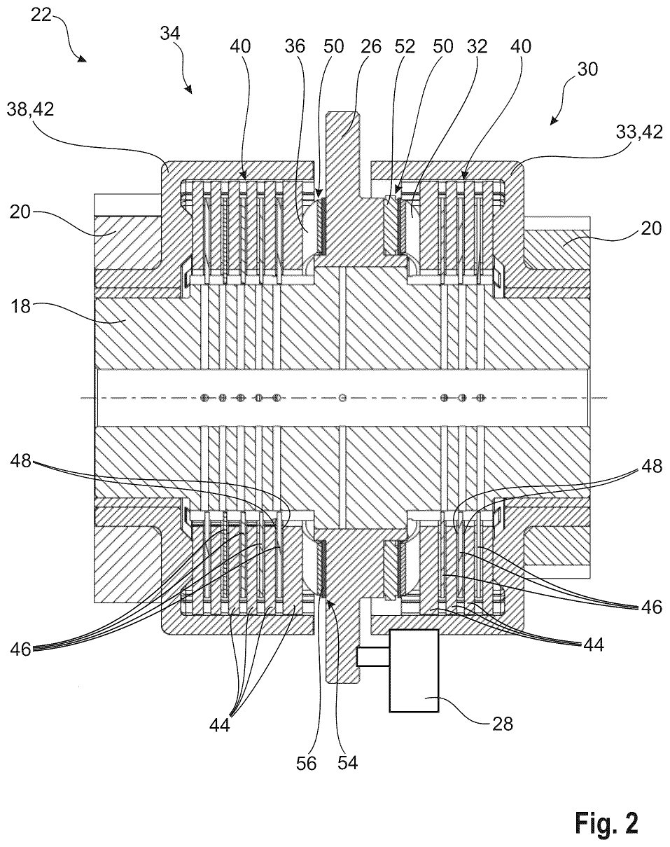

In the following, the structure of the friction clutch 22 will be explained in more detail with reference to FIG. 2.

The friction clutch 22 has an actuating sleeve 26 which is seated on the shaft 18 and can be shifted linearly along the shaft 18.

The actuating sleeve 26 can be arranged on the shaft 10 for joint rotation therewith, as is the case in FIG. 2.

Alternatively, the actuating sleeve 26 can also be rotatably mounted on the shaft 18.

An actuator 28 which will be discussed in more detail later is provided to shift the actuating sleeve 26.

In addition, the friction clutch 22 comprises a first friction clutch unit 30, which is arranged in the axial direction on one side of the actuating sleeve 26, and a first spring unit 32, which is provided axially between the actuating sleeve 26 and the first friction clutch unit 30.

The first friction clutch unit 30 has a first clutch body 33 which is rotatably mounted on the shaft 18 and is coupled to one of the gear wheels 20 for joint rotation therewith.

The friction clutch also includes a second friction clutch unit 34 which is arranged in the axial direction on the side of the actuating sleeve 26 which is opposite the first friction clutch unit 30, and a second spring unit 36 which is provided axially between the actuating sleeve 26 and the second friction clutch unit 34.

The second friction clutch unit 34 has a second clutch body 38, which is also rotatably mounted on the shaft 18 and is coupled to the other of the two gear wheels 20 for joint rotation therewith.

The first and the second spring unit 32, 36 may comprise a wave ring or a disk spring or a pack of wave rings or disk springs.

The friction clutch 22 shown in FIG. 2 corresponds to a first alternative, in which the first friction clutch unit 30 and the second friction clutch unit 34 each comprise a multidisk clutch 40.

Each of the multidisk clutches 40 has an outer disk carrier 42, which is formed by the respective clutch body 33, 38.

Alternatively, it is also possible to provide a separate outer disk carrier, which is respectively coupled to the clutch bodies 33, 38.

Outer disks 44 are respectively provided within the outer disk carriers 42 and are coupled to the outer disk carrier 42 for joint rotation therewith.

Furthermore, inner disks 46 which are coupled to the shaft 18 for joint rotation therewith are also provided within each outer disk carrier 42.

The inner disks 46 of the respective multidisk clutch 40 have a friction lining 48 on both sides, while the outer disks 44 are designed as steel disks. This can also be designed the other way round.

Axial bearings 50 are also present. They can be designed as a needle bearing 52 (see FIG. 2, right side of the actuating sleeve 26) or also as a plain bearing 54 having a sliding disk 56 (see FIG. 2, left side of the actuating sleeve 26).

Alternatively, additional bearings or sliding rings can be dispensed with by an appropriate coating and/or hardening of the contacting parts between which a relative speed may be present. The needle bearing 52, for example, can thus be omitted. In this alternative, the plain bearing is thus formed by the coating and/or hardening of the parts themselves.

This allows the spring units 32, 36 to be supported on the respective axial bearing 50 and on the axially opposite side on an outer disk 44, as shown in the arrangement in FIG. 2. If there is a speed difference between the actuating sleeve 26 and the outer disk carriers 42 and thus also the outer disks 44, the axial bearings 50 allow the spring units 32, 36 to move therewith.

This can prevent or at least reduce friction and thus also wear.

Alternatively, the inner disks 46 can also be designed as steel disks, and the outer disks 44 can be provided with a friction lining 48. In this design, the disk pack formed from the outer disks 44 and inner disks 46 advantageously ends with an inner disk 46 (not shown in FIG. 2) towards the actuating sleeve 26.

It is thus ensured that the spring units 32, 36 are not subjected to any relative speeds in the case of an actuating sleeve 26 connected to the shaft 18 for joint rotation therewith towards the multidisk clutch, since the inner disks 46, like the actuating sleeve 26, are coupled to the shaft 18. Consequently, an axial bearing would not be necessary in such a design.

The shifting of the friction clutch 22 by means of the actuating sleeve 26 will be discussed below with reference to FIG. 2.

In FIG. 2, the actuating sleeve 26 is in a neutral position.

In the neutral position of the actuating sleeve 26, both of the spring units 32, 36 of the friction clutch units 30, 34 are axially prestressed so that an axial force acts on each of the multidisk clutches 40.

In the neutral position of the actuating sleeve 26, an at least approximately identical magnitude of the axial force respectively acts on the first and the second friction clutch unit 30, 34 due to the prestressed first and second spring units 32, 36.

Starting from the neutral position, the actuating sleeve 26 can be shifted towards the first friction clutch unit 30 (to the right) into a first engaged state.

This generates a frictional fit in the first friction clutch unit 30, so that there is a rotational connection between the shaft 18 and the first clutch body 33 and therefore also the gear wheel 20.

When the actuating sleeve 26 is shifted axially from the neutral position towards the first friction clutch unit 30 into the first engaged state, the magnitude of the axial force acting on the second friction clutch unit 34 is zero or at least reduced compared to the neutral position.

As a result, there is as little friction as possible within the second friction clutch unit 34 when the actuating sleeve 26 is in the first engaged state.

Furthermore, the actuating sleeve 26 can also be shifted from the neutral position into a second engaged state towards the second friction clutch unit 34 (to the left).

As a result, a frictional fit is generated within the second friction clutch unit 34, and thus a rotational connection is present between the shaft 18 and the second clutch body 38 and thus also the gear wheel 20.

Here too, with the axial shifting of the actuating sleeve 26 into the second engaged state, the amount of the axial force acting on the first friction clutch unit 30 is zero or at least reduced compared to a neutral position.

As already explained in relation to the second friction clutch unit 34, this serves to generate, in the first friction clutch unit, as little friction as possible within the first friction clutch unit 30 when the actuating sleeve 26 is in the second engaged state.

Furthermore, it is thus achieved that the transition is “smooth” when the actuating sleeve is shifted from one engaged state to the other, since the shifting of the actuating sleeve 26 causes a frictional fit within one friction clutch unit to be released and a frictional fit to be produced in the other friction clutch unit practically immediately thereafter.

This allows a “shifting” without load interruption between the gear steps.

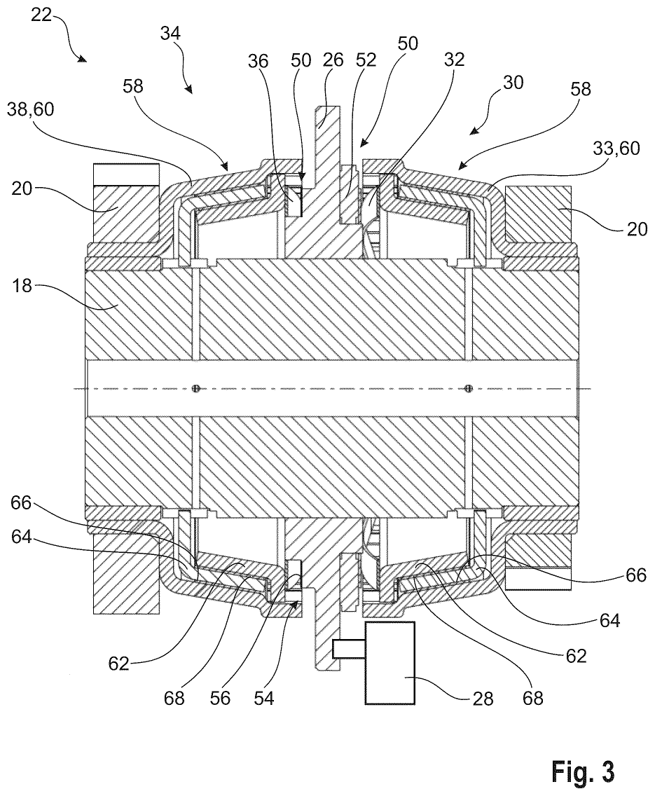

FIG. 3 shows a friction clutch 22 with friction clutch units 30, 34 according to a second alternative.

In contrast to the friction clutch 22 shown in FIG. 2, the first and the second friction clutch unit 30, 34 each have a cone clutch 58.

Both cone clutches 58 comprise an outer cone friction ring carrier 60, which simultaneously forms the respective clutch body 33, 38. The outer cone friction ring carriers 60 form a conical, radially inwardly pointing friction surface (inner cone surface 66), which is available for torque transmission.

A first cone friction ring element 62 is arranged within the outer cone friction ring carrier 60 of the cone clutches 58 and is coupled to the outer cone friction ring carrier 60 for joint rotation therewith.

In addition, a second cone friction ring element 62 is provided in each of the outer cone friction ring carriers 60, which is coupled to the shaft 18 for joint rotation therewith.

The second cone friction ring element 64 is arranged between the outer cone friction ring carrier 60 and the first cone friction ring element 62 and can be brought into contact with the inner cone surface 66 of the outer cone friction ring carrier 60 and an outer cone surface 68 of the first cone friction ring element 62 by applying an axial force to the cone clutch 58.

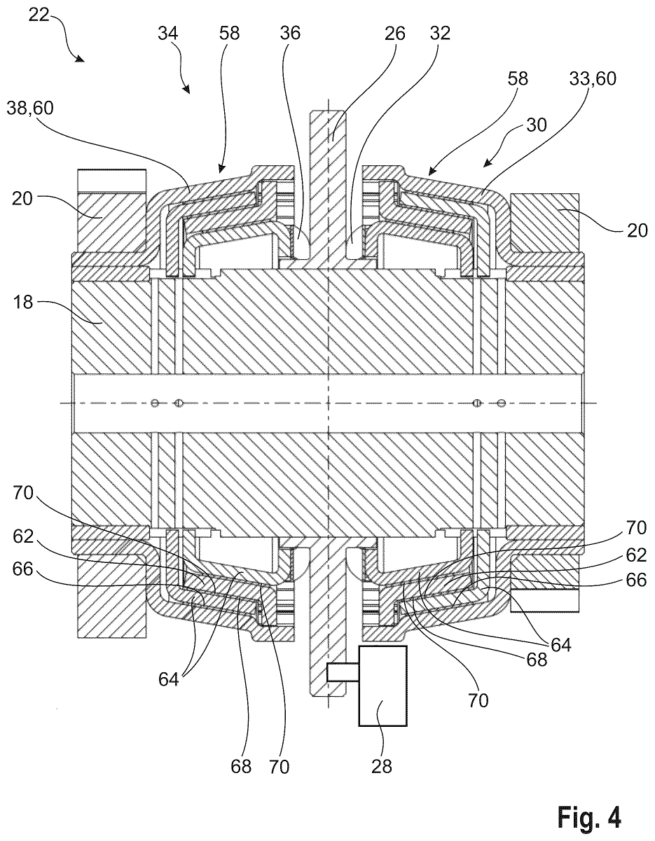

FIG. 4 shows a further friction clutch 22 with friction clutch units 30, 34 according to a third alternative.

In contrast to the friction clutch 22 shown in FIG. 3, the friction clutch units 30, 34 according to the third alternative have two second cone friction ring elements 64, which are coupled to the shaft 18 for joint rotation therewith. Furthermore, no axial bearings are provided.

The first cone friction ring element 62 is arranged between the two second cone friction ring elements 64, the second cone friction ring elements 64 having friction surfaces 70 which face the first cone friction ring element 62. On the outside, the respective inner cone surface 66 serves as a support and friction surface.

In addition, the spring units 32, 36 are also supported on the radially innermost cone friction ring element. However, in contrast to the friction clutch 22 shown in FIG. 3, this is a second cone friction ring element 64.

Since the actuating sleeve 26 and also the second cone friction ring elements 64 are coupled to the shaft 18 for joint rotation therewith, the spring units 32, 36 are not subjected to any relative speeds which could lead to friction and thus to wear.

Thus, no axial bearing is necessary with such a design.

With regard to the shifting of the friction clutch 22 by means of the actuating sleeve 26, the explanations regarding the first alternative apply also with respect to the friction clutch units 30, 34 according to a second and a third alternative.

Furthermore, it is also conceivable that one of the friction clutch units comprises a multidisk clutch and the other a cone clutch, or that at least one of the friction clutch units comprises both a multidisk clutch and a cone clutch (not shown in the figures).

As already indicated in the introductory part, the actuating sleeve 26 can be shifted via the actuator 28.

Various types of actuators are conceivable for shifting the actuating sleeve 26.

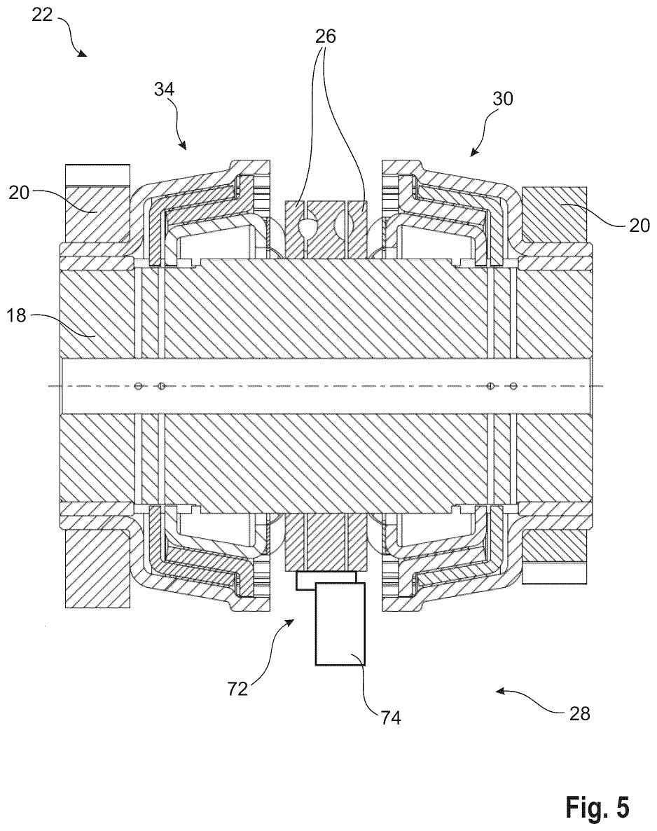

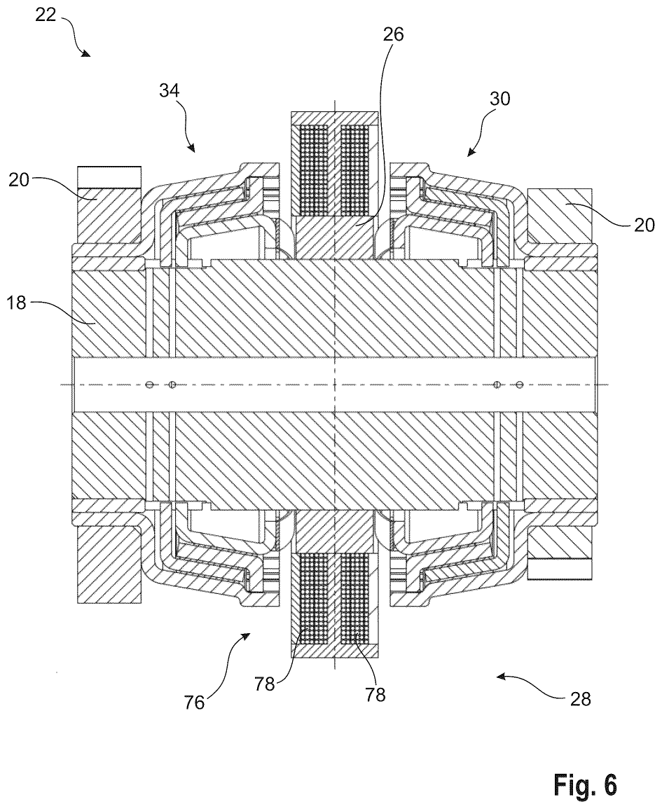

Two possible actuators are shown by way of example in FIGS. 5 and 6 only for a friction clutch 22 with friction clutch units 30, 34 according to the third alternative, but they are also applicable to the other embodiments.

To improve clarity, only the most relevant components are provided with reference numerals in FIGS. 5 and 6.

The actuation sleeve 26 can be coupled to a ball ramp actuator 72, as shown in FIG. 5.

In this option, the actuating sleeve 26 forms part of the ball ramp actuator 72, which in turn has a drive 74 to shift the actuating sleeve 26.

As shown in FIG. 6, the actuating sleeve 26 can also be coupled to an electromagnetic actuator 76.

The electromagnetic actuator 76 includes coils 78, the actuating sleeve 26 serving as a coil core and being adapted to be shifted axially along the shaft 18 by energizing the coils 78.

Furthermore, it is also conceivable that the actuating sleeve 26 is coupled to an electromechanical actuator or to a hydraulic actuator, although this is not shown in the drawings.

While the disclosure has been described with reference to a preferred embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A friction clutch of a multispeed transmission, comprising:
an actuating sleeve which is seated on a shaft and is adapted to be shifted linearly along the shaft between a first engaged state and a second engaged state,
a first friction clutch unit arranged in the axial direction on one side of the actuating sleeve and comprising a first clutch body which is rotatably mounted on the shaft,
a second friction clutch unit arranged in the axial direction on the side of the actuating sleeve which is opposite the first friction clutch unit and comprising a second clutch body which is rotatably mounted on the shaft,
a first spring unit arranged axially between the actuating sleeve and the first friction clutch unit,
a second spring unit arranged axially between the actuating sleeve and the second friction clutch unit,
the spring units axially prestressing both friction clutch units when the actuating sleeve is in a neutral position,
the actuating sleeve producing a frictional fit in the first friction clutch unit in the first engaged state, and a rotational connection being thus present between the shaft and the first clutch body, and
the actuating sleeve producing a frictional fit in the second friction clutch unit in the second engaged state, and a rotational connection being thus present between the shaft and the second clutch body.

2. The friction clutch according to claim 1, wherein at least on one side facing the friction clutch units, the actuating sleeve has an axial bearing assigned thereto, on which the respective spring unit is supported in the axial direction.

3. The friction clutch according to claim 2, wherein the axial bearing is a needle bearing or a plain bearing which comprises a sliding disk.

4. The friction clutch according to claim 1, wherein, in a neutral position of the actuating sleeve, at least an approximately identical axial force acts respectively on the first and the second friction clutch unit, which is caused by the respectively prestressed associated first or second spring unit between the actuating sleeve and the first or the second friction clutch unit.

5. The friction clutch according to claim 1, wherein, with an axial shifting of the actuating sleeve into the first engaged state, the magnitude of the axial force acting on the second friction clutch unit is zero or reduced compared to the neutral position, and/or wherein with an axial shifting of the actuating sleeve into the second engaged state, the magnitude of the axial force acting on the first friction clutch unit is zero or reduced compared to the neutral position.

6. The friction clutch according to claim 1, wherein the first and/or the second clutch body is/are coupled to a gear wheel for joint rotation therewith.

7. The friction clutch according to claim 1, wherein at least one of the first or the second friction clutch unit comprises a multidisk clutch.

8. The friction clutch according to claim 7, wherein the respective multidisk clutch has an outer disk carrier which is formed by the respective clutch body or is coupled thereto for joint rotation therewith, and wherein within the outer disk carrier, outer disks are provided which are coupled to the outer disk carrier for joint rotation therewith, and inner disks which are coupled to the shaft for joint rotation therewith.

9. The friction clutch according to claim 8, wherein the outer disks of the respective multidisk clutch are provided on both sides with a friction lining and the inner disks are steel disks.

10. The friction clutch according to claim 9, wherein the disk pack ends with an inner disk towards the actuating sleeve.

11. The friction clutch according to claim 1, wherein the first and/or the second friction clutch unit comprise(s) a cone clutch.

12. The friction clutch according to claim 11, wherein the respective cone clutch has an outer cone friction ring carrier which is coupled to the shaft for joint rotation therewith and is formed by the respective clutch body.

13. The friction clutch according to claim 12, wherein at least a first cone friction ring element which is coupled to the outer cone friction ring carrier for joint rotation therewith, and at least a second cone friction ring element which is coupled to the shaft for joint rotation therewith, are arranged at least partially within the outer cone friction ring carrier.

14. The friction clutch according to claim 13, wherein the outer cone friction ring carrier has an inner cone surface against which the second cone friction ring element can rest, which is located between the outer cone friction ring carrier and the first cone friction ring element.

15. The friction clutch according to claim 13, wherein the respective cone clutch comprises a first cone friction ring element and two second cone friction ring elements between which the first cone friction ring element is located and which each have a friction surface facing the first cone friction ring element.

16. The friction clutch according to claim 13, wherein the respective elastic spring unit is supported on the radially innermost cone friction ring element.

17. The friction clutch according to claim 1, wherein at least one of the first or second elastic spring unit comprises at least one wave ring or one disk spring or a pack of these elements.

18. The friction clutch according to claim 1, wherein the actuating sleeve is arranged on the shaft for joint rotation therewith or wherein the actuating sleeve is rotatably mounted on the shaft.

19. The friction clutch according to claim 1, wherein the actuating sleeve is coupled to an electromechanical actuator or to a hydraulic actuator or to an electromagnetic actuator or to a ball ramp actuator for actuation.

20. An electric drive of a vehicle having a two-speed transmission and an electric motor coupled via a friction clutch according to claim 1.
